(19) United States
(12) Patent Application Publication
(10) Pub. No.: US 2006/0292273 A1
(43) Pub. Date: Dec. 28, 2006

(54) Food coating compositon and method of making the same

(76) Inventors: Arthur H. Konwinski, Fort Wayne, IN (US); Thomas R. Katen, Willshire, OH (US); Charles T. Worrall, Fort Wayne, IN (US)

Correspondence Address: Holly M Amjad;Solae, PO Box 88940, St Louis, MO, 63188, US

(21) Appl. No.: 10/521,145

(22) PCT Filed: Jul. 22, 2003
(86) PCT No.: PCT/US03/22844

§ 371 Date: Aug. 23, 2006

Related U.S. Application Data
(60) Provisional application No. 60/397,548, filed on Jul. 22, 2002.

(51) Int. Cl. A23L 1/00

(52) U.S. Cl. 426/296

(57) ABSTRACT

A method for producing a high-protein coating composition for coating a food substrate including the steps of providing a soy protein mixture having at least about 40% by weight of a soy protein; adding water to said soy protein mixture to produce a mass; cooking said mass in an extruder at a temperature of between about 135° C. and about 145° C.; converting said cooked mass into particles; and drying said particles to form the high-protein coating composition. The high-protein coating composition has a fat absorbability and contains at least about 30 weight % of protein.

### BACKGROUND OF THE INVENTION

1. Field of the Invention

This invention relates to a food coating composition and method of making the same. More particularly, the present invention is directed to a high-protein coating composition that absorbs less fat and increases the overall protein content of a portion of meat, vegetable or other food item.

2. Description of the Related Art

There are numerous types of food products that include a portion of meat, vegetable, cheese and/or other filling, coated with a batter and/or breading composition. Unfortunately, the quality of such food products often tends to degrade in texture and appearance when stored for long periods of time. This is believed to be due to the migration of moisture from the moist meat, vegetable, cheese or other filling to the coating component. The problem is magnified when the coated food products are stored in a deep freezer and then thawed. The condensation that occurs when thawing the food product is absorbed by the coating, resulting in a soggy food product.

The texture of the coated food products also tends to degrade when the coated food products are heated in a microwave. In this case, the microwave heating causes migration of moisture from the moist filling component to the coating component. Furthermore, unlike in a conventional oven, the air surrounding the coated food product in the microwave oven is not heated to any substantial degree, and therefore moisture is not effectively removed or evaporated from the coating component. As a result, the coating component becomes soggy.

A number of attempts have been made to improve breading and batter compositions to address these disadvantages. For example, one attempt includes producing a coating that includes more than 30 weight percent of a heat set protein, such as gluten. The heat set proteins are produced by extrusion cooking a proteinaceous mass at relatively low temperatures, between 60° C. and 120° C. and drying the resulting protein-enriched crumb to a moisture content of less than 10%. For oven and microwave applications, it is recommended that the coating also include some form of fat. The heat set protein is believed to withstand and resist moisture, while the fat reduces the hardness.

In the fast-food environment, coatings have been made that include about 1 to 10 weight percent of a heat-set protein and up to 3 weight percent added fat. Such coatings are believed to maintain crispy texture and golden appearance when the coated food products are fried or baked and then held for a period of time under food-heating lights, in heated-holding cabinets, on steam tables, or otherwise. Such coatings are also believed to maintain crispness and appearance when frozen fast-food products are subjected to repeated freeze-thaw cycles.

A method has also been developed to enhance the crispness and golden brown appearance of food products without overcooking the food or unduly increasing its uptake of oil during frying over extended periods of time. This method involves applying batter and breading to a food substrate, and then applying an aqueous dispersion of a water-dispersible protein which is capable of forming a thermally irreversible film by dehydration on heating and freezing.

Generally, the art has been concerned with the crispness and appearance of coated food products after they are stored in a frozen condition, and then heated and possibly held prior to serving. Consequently, the proposed solutions have focused on including components that function to maintain appearance and crispness, not on the overall nutritional quality and content of the coated food product.

The nutritional quality and content of food products has become an increasingly important issue to consumers. In fact, after considering the issue of nutrition in school-provided lunches, the United States Government enacted the National School Lunch Program (NSLP). NSLP is a federally assisted meal program operating in more than 97,700 public schools, non-profit private schools, and residential childcare institutes. Under the NSLP, schools that choose to participate in the NSLP lunch program receive cash subsidies and donated commodities from the United States Department of Agriculture (USDA) for each meal they serve. In return, the schools are required to serve lunches that meet the Federal nutritional requirements, and they must offer free or reduced-priced lunches to eligible children. See 7 C.F.R. §210

The Federal nutritional requirements include the recommendations of the Dietary Guidelines for Americans, which advises that no more than 30 percent of an individual's calories derive from fat, and less than 10 percent from saturated fat. The Federal nutritional requirements also require that the school lunch provide one-third of the Recommended Dietary Allowances of protein, vitamin A, vitamin C, iron, calcium and calories.

Although the Federal Government has set the nutritional requirements, the State and local school authorities decide which specific foods to serve and how such foods are prepared. The USDA works with State and local agencies to teach and motivate children to make healthy food choices, and to provide school service staff with training and technical support. Through the NSLP, schools provide nutritionally balanced, low-cost lunches to more than 2 million children each school day.

Accordingly, a need remains for a food coating composition for coating a portion of meat, vegetable or other food-item that maintains texture and appearance during freezing, thawing, heating, preparation, and storing, while absorbing less fat and/or increasing the overall protein content of a portion of meat, vegetable or other food item.

### SUMMARY OF THE INVENTION

The present invention provides a method for producing a high-protein coating composition for coating a food substrate including the steps of providing a soy protein mixture having at least about 40% by weight of a soy protein; adding water to said soy protein mixture to produce a mass; cooking said mass in an extruder at a temperature of between about 135° C. and about 145° C.; converting said cooked mass into particles; and drying said particles to form the high-protein coating composition. The high-protein coating composition has a low fat absorbability and contains at least about 30 weight % of protein.

The present invention also provides a high-protein that has a low fat absorbability and has a protein content of at least about 30 weight % of protein.

### DETAILED DESCRIPTION

The coating compositions of die present invention generally include a high protein component, such as textured soy protein, in an amount sufficient to significantly increase the overall amount of protein contained in the food product in which it is used. The amount of the protein component in the coating composition may be varied as desired to produce a coating that has a protein content of at least about 30 wt. %. Preferably, the coating composition includes between about 40 and about 100 parts by weight (weight %) of a suitable soy protein component. Suitable soy protein components may include soy protein flours, concentrates or isolates such as those disclosed in U.S. patent application Ser. No. 09/930,733, entitled “Soy protein product and process for its manufacture,” filed on Aug. 15, 2001; U.S. patent application Ser. No. 10/118,764, entitled “Soy protein concentrate having high isoflavone content and process for its manufacture,” filed on Apr. 9, 2002; U.S. patent application Ser. No. 10/406,429, entitled “Process for producing a high solubility, low viscosity, isoflavone-enriched soy protein isolate and the products thereof,” filed on Apr. 3, 2003; and U.S. patent application Ser. No. 10/431,188, entitled “Process to produce isoflavone depleted vegetable protein material,” filed on May 7, 2003. When using soy protein, the amount of the protein component in the coating composition may be varied to limit and control the natural taste of the soy protein. Although soy protein is the preferred high protein component, other high protein ingredients may be used in the alternative, including whey protein, calcium caseinate, nonfat dry milk powder, skim milk powder, and the like.

The coating composition may include between about 0 and about 60 parts by weight of additional ingredients, such as wheat gluten, wheat starch, corn starch, potato flour, rice flour, and/or spices. Preferably, the coating composition contains about 0-20 parts by weight of wheat gluten, about 0-20 parts by weight of wheat starch, about 0-10 parts by weight of corn starch, about 0-30 parts by weight of potato flour, about 0-30 parts by weight of rice flour, and/or about 0-5 parts by weight of spices.

According to the present invention, the method of producing the coating composition generally involves combining the ingredients to form a mass, cooking the mass, drying the cooked mass to produce the coating composition, and milling the coating composition to a desired particle size.

In one particular embodiment, the ingredients are combined to form a mixture. The mixture is then added, along with water and/or steam, to an extruder preconditioner, such as a twin shaft preconditioner, to produce the mass. Water and/or steam may be added in an amount sufficient to allow the extruder to shape and cook the mass. Preferably, the water and/or steam is added in an amount sufficient to achieve a moisture content of between about 25% and 35%.

The resulting mass is then cooked until the mass is set. The coolcng step may be performed in an extruder. In which case, the mass may then be fed to an extruder, where it is preferably cooked at temperatures between about 135° C. and about 145° C. The cook time depends on the length of the extruder, screw diameter, and screw speed. Any suitable combination of extruder length and speed may be used. For example, successful results have been achieved when using a twin-screw extruder having a length of between 50.8 cm (20 inches) and 101.6 cm (40 inches) and a screw speed between about 250 rpm and about 350 rpm. It should be understood that the mass may, alternatively, be cooked by means other than extrusion, such as baking.

The cooked mass then exits the extruder through at least one die hole or holes, at which point it is cut by a die knife into pellets. The pellets may then be further reduced to a desirable size using a milling device. Preferably, the particles are reduced in size using a nulling device, and are then screened using a mesh screen having between about 3.94 holes/cm (10 holes/inch)-7.87 holes/cm (20 holes/inch). screen. Although the pellets may be reduced to any desired particle size, it has been found that soy-based coating compositions of the present invention having smaller particle sizes demonstrate a slightly better taste (less of a “soy” flavor) than soy-based coating compositions having a larger particle size. It should be noted that there is no significant variation in protein content between the different sized particles, consequently this taste difference is not due to a variation in protein content. Finally, the reduced pieces may then be dried in a drier, such as a conveyer drier, to reduce the moisture content to less than about 10%.

The coating compositions of the present invention may be applied to a core substrate of meat, poultry, seafood, vegetable, cheese or other food item to produce coated and/or extended food products. In producing a coated food product, coating compositions of the present invention may be applied to the substrate by extrusion, dipping, spraying, shaking, or other means. The coating composition may also be used in conjunction with a batter to aid in the adherence of the coating composition to the substrate.

Once applied, the coating is set by parfrying (partially fried), flash frying, oven frying, baking, or otherwise cooking the raw coated food product. It has been discovered that the coating compositions of the present invention absorb substantially less oil and fat during setting as compared to prior coating compositions. The resulting partially cooked coated food product may then be frozen, stored and/or distributed for later consumption. The frozen, partially cooked coated food product may be fully cooked using a microwave, oven, toaster or other cooking/warming device. It has been further discovered that the coating compositions of the present invention absorb substantially less oil and fat during the full cooking as compared to prior coating compositions. Alternatively, the raw coated food product may proceed directly to full cooking to simultaneously set the coating and cook the food product. The resulting cooked coated food product may be consumed or frozen for later consumption

Rather than coating the meat, poultry, seafood, vegetable, or other substrate, the coating compositions of the present invention may be used to extend the substrate by mixing the coating composition directly into the substrate. The extended food product may then be coated with either a conventional breading or a coating composition of the present invention, and cooked as described above. Alternatively, the extended food product may be cooked without being coated.

The coating compositions of the present invention are high in protein and, consequently, use of the coating compositions increases the overall protein content of a portion of the core substrate. Thus, using the high-protein coating compositions of the present invention may help institutions meet the dietary demands of consumers. Furthermore, use of the high-protein coating compositions of the present invention may also help institutions comply with government regulations and standards, thereby enabling participation in government-funded programs, such as the National School Lunch Program (NSLP).

In addition, it has been determined that the coating compositions of the present invention have a lower fat absorption than traditional wheat flour breading compositions. In other words, when cooking the coated food product, the coating compositions of the present invention absorb less fat and/or oil that conventional breadings. Accordingly, use of the coating compositions of the present invention produces products having a lower fat to calorie ratio, thereby further enabling institutions to meet dietary demands and requirements. It has been further demonstrated that the coating compositions of the present invention, maintain texture and appearance after freezing, thawing and re-heating.

These and other aspects of the present invention may be more readily understood by reference to the following examples.

### EXAMPLE I

In this Example, a Control coated chicken patty coated with conventional bread crumbs was prepared and compared to a Test coated chicken patty coated with a soy-based coating composition according to the present invention. The content of each of the chicken patties is provided in Table 1 below. The chicken patties, which were extended as indicated by their composition, were prepared in a conventional manner. To simulate anticipated commercial processing and use, each of the chicken patties in this Example were first coated with batter. Next, each of the chicken patties was coated with either bread crumbs, or soy coating composition, as indicated in Table 1. Each of the chicken patties was then parfried, fully cooked and then frozen. Finally, each of the chicken patties was re-heated in a microwave oven.

TABLE 1
CONTENT OF CONTROL AND TEST CHICKEN PATTIES

| | | |
|---|---|---|
| | Control Coated | Test Coated Chicken |
| | Chicken Patty | Patty |
| Ingredient | (wt. %) | (wt. %) |

Chicken Patty:

| | | |
|---|---|---|
| Chicken Breast | 46.00 | 46.00 |
| Chopped Chicken Skin | 11.50 | 11.50 |
| RESPONSE ® 4410¹ | 6.67 | 6.67 |
| (2.6 to 1.0) | | |
| Hydration Water | 17.39 | 17.39 |
| Mod. Food Starch 05735² | 0.83 | 0.83 |
| Salt | 0.67 | 0.67 |
| MSG (monosodium | 0.21 | 0.21 |
| glutamate) | | |
| Onion Powder | 0.05 | 0.05 |
| Garlic Powder | 0.02 | 0.02 |

Batter:

| | | |
|---|---|---|
| Batter Water | 4.71 | 5.40 |
| All Purpose Flour | 1.66 | 1.66 |
| Batter Starch³ | 0.69 | 0.00 |
| Corn Flour | 0.22 | 0.22 |
| Salt | 0.17 | 0.17 |
| Baking Powder | 0.03 | 0.03 |
| Bread Crumbs⁴ | 9.20 | — |
| Soy Coating Composition⁵ | — | 9.20 |

¹Textured soy protein concentrate available form Central Soya Company, Inc.
²Stabilized and crosslinked corn starch.
³Oxidized corn starch.
⁴Wheat flour breading.
⁵91 wt. % soy protein concentrate and 9 wt. % rice flour.

The soy coating composition used in this Example was prepared by combining 91 parts by weight of a soy protein concentrate with 9 parts by weight rice flour. This mixture was then metered at a rate of 120 lb/hr into an extruder twin-shaft preconditioner, where sufficient water and live steam were injected to raise the moisture content to about 34 wt. % and the temperature to 79° C. (175° F.). The mixture was discharged from the preconditioner and continuously fed therefrom into an extruder (Wenger X-20) having a screw diameter of 8.25 cm (3.25 inches), a screw speed of 300 rpm, and a length of 76.2 cm (30 inches). The extruder was equipped with a single die hole, 0.925 cm×0.925 cm (⅜ inch×⅜ inch) square and the temperature in the extruder barrel was 146° C. (295° F.). A die knife was used to cut the extrudate into chunks about 1.27 cm (½ inch) long. The extruded, die cut pieces were fed into a Fitzmill for further size reduction. The size reduced pieces were dried to less than 10 wt. % moisture in a Proctor & Schwartz continuous conveyor dryer.

Calculations were also performed to determine the fat level of the chicken patties. The results are listed and compared in Table 2 below. The chicken patty having the conventional whole wheat flour breading was found to have over 20% (1.78 wt. %) more fat than the chicken patty having the soy-based coating composition of the present invention. This difference in fat content indicates that the soy-based coating composition of the present invention absorbed less oil (and fat) during the flash frying than the traditional whole wheat breading.

TABLE 2
FAT AND PROTEIN CONTENT OF CONTROL
AND TEST CHICKEN PATTIES

| | Control Coated Chicken | Test Coated Chicken Patty |
|---|---|---|
| Content | Patty (wt. %) | (wt. %) |
| Fat | 10.11 | 8.33 |

Calculations were also performed to determine the protein level as a percentage of the Food Buyer's Guide credit (FBG % Credit) and the proportion costs of the chicken patties. This data is presented in Table 3 below. The Food Buyer's Guide credit (FBG % Credit) refers to the Food Buying Guide for Child Nutrition Programs. This Guide is used by schools to ensure that they purchase the necessary amount of foods to meet the nutritional requirements of the NSLP. This Guide sets forth both the proportion or serving size and nutrition level (including protein level) to standardize yields. The reference herein to “protein credit” refers to the amount of protein that contributes to or is “credited toward” the protein requirements of meals as set forth in the Federal nutrition requirements of the NSLP. In Table 4 below, the costs per portion are provided.

TABLE 3

| | Raw Portion (oz) | | Wt. % in Formula | | FBG % Credit | | Credit Ounces | |
|---|---|---|---|---|---|---|---|---|
| | Control | Sample | Control | Sample | Control | Sample | Control | Sample |
| Chicken Breast | 3.25 | 2.25 | 46.00 | 46.00 | 70 | 70 | 1.047 | 0.725 |
| Chicken Skin | | | 11.50 | 11.50 | 70 | 70 | 0.262 | 0.181 |
| Hydrated Soy Protein | | | 24.00 | 24.00 | 100 | 100 | 0.780 | 0.540 |
| Batter Soy | | | 0.00 | 0 | 0 | 0 | 0.000 | 0.000 |
| Breading Soy | | | 0.00 | 30.12 | 0 | 100 | 0.000 | 0.678 |

TABLE 4

| | Control | Sample |
|---|---|---|
| Raw Portion (oz) | 3.25 | 2.25 |
| Cost (lb.) | 85.06 | 90.44 |
| Cost (oz) | 5.32 | 5.65 |
| Cost per Portion | $0.1728 | $0.1272 |

Table 4 demonstrates that the costs per portion show a savings of over $0.04 (4.56¢) for an equal amount of protein credit even though the raw portion of the chicken in the control (92.1 grams) (3.25 oz) was greater than the raw portion of the chicken in the Sample (63.79 grams) (2.25 oz). This difference is due to the protein credit provided by the soy in the breading in the Sample. As can be appreciated, by improving the protein credit of a food product according to the present invention, it is possible to lower the size of the food portion. This is because a smaller amount of food product having a higher protein content can equal the protein credit given to a larger portion of a food product having a lower protein content. A benefit of the present invention is that children are apt to ingest a larger amount of protein when they do not finish their meals, particularly children who tend to eat the breading from a breaded food product.

### EXAMPLE II

In Examples II-VIII, different coating compositions were made in accordance with the present invention. The resulting coating compositions were compared in Example IX. In Example II, a coating composition of the present invention was made. PROCON® 2000, a soy protein concentrate available from Central Soya Company, Inc., was metered at a rate of 120 lb/hr into an extruder twin-shaft preconditioner. Sufficient water and steam were injected into the preconditioner to raise the moisture content to about 34% and the temperature to about 77° C. (170° F.). The mixture was discharged from the preconditioner and continuously fed therefrom into an extruder (model: Wenger X-20) having a screw diameter of 8.25 cm (3.25 inches), a screw speed of 300 rpm, and a length of 76.2 cm (30 inches). The extruder was equipped with a single die hole, 0.925 cm×0.925 cm (⅜ inch×⅜ inch) square and the temperature in the extruder barrel was 138° C. (280° F.). A die knife was used to cut the extrudate into chunks about 1.27 cm (½ inch) long. The extruded, die cut pieces were fed into a Fitzmill for further size reduction. The size reduced pieces were dried to less than 10 wt. % moisture in a Proctor & Schwartz continuous conveyor dryer.

### EXAMPLE III

In this Example a coating composition was prepared by combining 70 parts by weight of soy protein concentrate (PROCON 2000), 20 parts by weight of wheat gluten, and 10 parts by weight of potato flour. This mixture was metered at a rate of 115 lb/hr into an extruder twin-shaft preconditioner, where sufficient water was injected to raise the moisture content to about 29%. The mixture was discharged from the preconditioner and continuously fed therefrom into an extruder (model: Wenger X-20) having a screw diameter of 8.25 cm (3.25 inches), a screw speed of 300 rpm, and a length of 76.2 cm (30 inches). The extruder was equipped with a single die hole, 0.925 cm×0.925 cm (⅜ inch×⅜ inch) square and the temperature in the extruder barrel was 146° C. (295° F.). A die knife was used to cut the extrudate into chunks about 1.27 cm (½ inch) long. The extruded, die cut pieces were fed into a Fitzmill for further size reduction. The size reduced pieces were dried to less than 10 wt. % moisture in a Proctor & Schwartz continuous conveyor dryer.

### EXAMPLE IV

In this Example a coating composition was prepared by combining 40 parts by weight of soy protein concentrate (PROCON 2000), 40 parts by weight of high solubility soy protein concentrate (ALPHA 5800 available from The Solae Company), and 20 parts by weight of wheat starch. This mixture was metered at a rate of 120 lb/hr into an extruder twin-shaft preconditioner, where sufficient water was injected to raise the moisture content to about 25%. The mixture was discharged from the preconditioner and continuously fed therefrom into an extruder (model: Wenger X-20) having a screw diameter of 8.25 cm (3.25 inches), a screw speed of 300 rpm, and a length of 76.2 cm (30 inches). The extruder was equipped with a single die hole, 0.925 cm×0.925 cm (⅜ inch×⅜ inch) square and the temperature in the extruder barrel was 135° C. (275° F.). A die knife was used to cut the extrudate into chunks about 1.27 cm (½ inch) long. The extruded, die cut pieces were fed into a Fitzmill for further size reduction. The size reduced pieces were dried to less than 10 wt. % moisture in a Proctor & Schwartz continuous conveyor dryer.

### EXAMPLE V

In this Example a coating composition was prepared by combining 80 parts by weight of soy protein concentrate (PROCON 2000), 10 parts by weight of corn starch, 5 parts by weight of potato flour, and 5 parts by weight of rice flour. This mixture was metered at a rate of 120 lb/hr into an extruder twin-shaft preconditioner, where sufficient water was injected to raise the moisture content to about 26%. The mixture was discharged from the preconditioner and continuously fed therefrom into an extruder (model: Wenger X-20) having a screw diameter of 8.25 cm (3.25 inches), a screw speed of 300 rpm, and a length of 76.2 cm (30 inches). The extruder was equipped with a single die hole, 0.925 cm×0.925 cm (⅜ inch×⅜ inch) square and the temperature in the extruder barrel was 143° C. (290° F.). A die knife was used to cut the extrudate into chunks about 1.27 cm (½ inch) long. The extruded, die cut pieces were fed into a Fitzmill for further size reduction. The size reduced pieces were dried to less than 10 wt. % moisture in a Proctor & Schwartz continuous conveyor dryer.

### EXAMPLE VI

In this Example a coating composition was prepared by combining 75 parts by weight of soy protein concentrate (PROCON 2000), 12.5 parts by weight of potato flour, and 12.5 parts by weight of rice flour. This mixture was metered at a rate of 120 lb/hr into an extruder twin-shaft preconditioner, where sufficient water was injected to raise the moisture content to about 26%. The mixture was discharged from the preconditioner and continuously fed therefrom into an extruder (model: Wenger X-20) having a screw diameter of 8.25 cm (3.25 inches), a screw speed of 300 rpm, and a length of 76.2 cm (30 inches). The extruder was equipped with a single die hole, 0.925 cm×0.925 cm (⅜ inch×⅜ inch) square and the temperature in the extruder barrel was 143° C. (290° F.). A die knife was used to cut the extrudate into chunks about 1.27 cm (½ inch) long. The extruded, die cut pieces were fed into a Fitzmill for further size reduction. The size reduced pieces were dried to less than 10 wt. % moisture in a Proctor & Schwartz continuous conveyor dryer.

### EXAMPLE VII

In this Example a coating composition was prepared by combining 60 parts by weight of soy protein concentrate (PROCON 2000), 15 parts by weight of potato flour, 15 parts by weight of rice flour, and 10 parts by weight of corn starch. This mixture was metered at a rate of 120 lb/hr into an extruder twin-shaft preconditioner, where sufficient water was injected to raise the moisture content to about 26%. The mixture was discharged from the preconditioner and continuously fed therefrom into an extruder (model: Wenger X-20) having a screw diameter of 8.25 cm (3.25 inches), a screw speed of 300 rpm, and a length of 76.2 cm (30 inches). The extruder was equipped with a single die hole, 0.925 cm×0.925 cm (⅜ inch×⅜ inch) square and the temperature in the extruder barrel was 138° C. (280° F.). A die knife was used to cut the extrudate into chunks about 1.27 cm (½ inch) long. The extruded, die cut pieces were fed into a Fitzmill for further size reduction. The size reduced pieces were dried to less than 10 wt. % moisture in a Proctor & Schwartz continuous conveyor dryer.

### EXAMPLE VIII

In this Example a coating composition was prepared by combining 40 parts by weight of soy protein concentrate (PROCON 2000), 30 parts by weight of potato flour, and 30 parts by weight of rice flour. This mixture was metered at a rate of 120 lb/hr into an extruder twin-shaft preconditioner, where sufficient water was injected to raise the moisture content to about 26%. The mixture was discharged from the preconditioner and continuously fed therefrom into an extruder (Wenger X-20) equipped with a single die hole, 0.925 cm×0.925 cm (⅜ inch×⅜ inch) square. The extruder screw speed was 300 rpm, and the temperature in the extruder barrel was raised to 135° C. (275° F.). A die knife was used to cut the extrudate into chunks about 1.27 cm (½ inch) long. The extruded, die cut pieces were fed into a Fitzmill for further size reduction. The size reduced pieces were dried to less than 10 wt. % moisture in a Proctor & Schwartz continuous conveyor dryer.

### EXAMPLE IX

In this Example, chicken patties were made using the formula in Table 3 below. A Control chicken patty was prepared by coating the chicken patties with conventional bread crumbs. Test chicken patties were prepared by coating a chicken patty with each one of the coating compositions from Examples 2 through 8. The moisture, fat and protein content of each of the coatings was measured and is shown in Table 4. Each of the coated chicken patties in this Example were first coated with batter and then coated with either bread crumbs, or one of the coating of Examples 2 through 8. As illustrated in Table 4, the resulting raw, breaded chicken patty contained approximately 6.38 weight % of fat. The coated chicken patties were then parfried in oil at 182° C. (360° F.) for 30 seconds, and baked in an oven at 177° C. (350° F.) until an internal temperature of 74° C. (165° F.) was reached. The moisture, fat and protein content of each of the finished/cooked coated chicken patties was measured and is shown in Table 5.

TABLE 3
CHICKEN PATTY FORMULA

| Ingredient | Parts by Weight |
|---|---|
| Chicken breast meat | 95.00 |
| Chicken skin | 5.00 |
| Water | 10.00 |
| Modified food starch | 1.13 |
| Salt | 0.91 |
| Chicken flavor | 0.85 |
| Sodium phosphate | 0.34 |
| Onion powder | 0.07 |
| Garlic powder | 0.03 |
| Ground white pepper | 0.03 |

TABLE 4
MOISTURE, FAT, AND PROTEIN CONTENT OF COATING
COMPOSITIONS AND RAW CHICKEN PATTY

| | Moisture | Fat | Protein |
|---|---|---|---|
| Coating Type | (% wt) | (% wt) | (% wt) |
| Bread crumbs | 8.74 | — | 9.98 |
| Example 2 | 5.12 | 0.04 | 68.37 |
| Example 3 | 3.36 | 0.31 | 66.08 |
| Example 4 | 5.10 | 0.01 | 58.49 |
| Example 5 | 4.72 | 0.10 | 57.23 |
| Example 6 | 5.29 | 0.10 | 53.93 |
| Example 7 | 4.98 | 0.05 | 44.48 |
| Example 8 | 6.14 | 0.01 | 32.56 |
| Raw, Coated Chicken Patty | — | 6.38 | — |

TABLE 5
MOISTURE, FAT, AND PROTEIN CONTENT OF
FINISHED/COOKED COATED CHICKEN PATTIES

| Patty Coating | Moisture (%) | Fat (%) | Protein (%) |
|---|---|---|---|
| Bread crumbs | 57.67 | 21.62 | 13.63 |
| Example 2 | 53.20 | 18.19 | 22.64 |
| Example 3 | 56.34 | 10.57 | 22.79 |
| Example 4 | 53.78 | 10.52 | 21.84 |
| Example 5 | 55.54 | 8.77 | 20.14 |
| Example 6 | 55.20 | 10.18 | 20.41 |
| Example 7 | 57.52 | 9.50 | 19.73 |
| Example 8 | 54.40 | 10.15 | 19.61 |

As shown in Table 5, the finished/cooked chicken patty having the conventional bread crumb coating was found to have an average of about 48% (10.49 wt. %) more fat than the chicken patties having the soy-based coating composition of the present invention. As demonstrated in Tables 4 and 5, the chicken patty having the conventional bread crumb coating increased in fat by 15.24% during the cooking process. In contrast, the chicken patties having soy-based coatings of the present invention increased in fat by an average of only 4.75% during the cooking process. This difference in fat content and fat pickup indicates that the soy-based coating compositions of the present invention absorb less oil (and fat) during the flash frying than the traditional bread crumb coatings. These results demonstrate that the coating composition of the present invention is resistant to the penetration and absorption of fat, thereby producing a coated chicken patty having a lower fat content and a higher protein to fat ratio.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for producing a high-protein coating composition for coating a food substrate comprising the steps of:
providing a soy protein mixture having at least about 40% by weight of a soy protein;
adding water to said soy protein mixture to produce a mass;
cooking said mass in an extruder at a temperature of between about 135° C. and about 145° C.;
converting said cooked mass into particles; and
drying said particles to form the high-protein coating composition.

2. The method of claim 1 wherein the soy protein is a soy protein concentrate, a high solubility soy protein, or a mixture thereof.

3. The method of claim 1 wherein said soy protein mixture further includes rice flour, potato flour, wheat gluten, wheat starch, coin starch, or mixture thereof.

4. The method of claims 2, and 3 wherein the step of providing a soy protein mixture includes combining the soy protein with the rice flour, potato flour, wheat gluten, wheat starch, corn starch, or mixture thereof.

5. The method of claim 1 wherein said step of adding water to said protein mixture includes adding water in an amount sufficient to the mass to have a moisture content of between about 25% and 35%.

6. The method of claims 1, 2, and 3 wherein the high-protein coating composition comprises at least about 30% by weight of protein.

7. The method of claims 1, 2, and 3 wherein the high-protein coating composition is resistant to the absorption of fat.

8. A coated food product comprising a food substrate and a coating composition produced by the method of claim 1, 2, 3 or 5.

9. The coated food product of claim 8, wherein said food substrate comprises meat, poultry, seafood, vegetable, cheese, or mixture thereof.

10. The coated food product of claim 8 wherein said coating composition absorbs less fat than coating composition consisting essentially of bread crumbs.

11. A method of preparing a coated food product comprising the steps of;
providing a food substrate;
coating the food substrate with the coating composition produced by the methods of claims 1, 2, 3, or 5 to produce a coated food substrate;
setting the coating on the coated food substrate to produce the coated food product.

12. The method of claim 11 wherein said step of setting the coating includes parfrying the coated food substrate.

13. The method of claim 11 wherein said step of setting the coating includes fully cooking the coated food substrate.

14. The method of claim 12 wherein parfrying the coated food substrate includes deep frying the coated food substrate.

15. The method of claim 12 wherein parrying the coated food substrate includes pan frying the coated food substrate.

16. The method of claim 11 wherein the coating composition absorbs less fat during the step of setting than coating composition consisting essentially of bread crumbs.

17. The method of claim 11 wherein the food substrate is meat, poultry, seafood, vegetable, cheese, or mixture thereof.
